(19) United States
(12) Patent Application Publication
(10) Pub. No.: US 2009/0195495 A1
(43) Pub. Date: Aug. 6, 2009

(54) LCD WITH SUB-PIXELS REARRANGEMENT

(76) Inventors: Chin-Hung Hsu, Tao-Yuan Hsien (TW); Chang-San Chen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/123,476

(22) Filed: May 20, 2008

(30) Foreign Application Priority Data
Jan. 31, 2008 (TW) 097103694

(51) Int. Cl. G09G 3/36

(52) U.S. Cl. 345/104

(57) ABSTRACT

An LCD includes a display panel, a source driver, a gate driver, a timing controller, and a data converter. The display panel includes a plurality of pixel units, and each pixel unit has three sub-pixels. Each pixel is driven according to one or two data lines. The sub-pixels of the display panel are arranged to improve the display effect. The data converter converts the image data to drive the display panel.

### BACKGROUND OF THE INVENTION

1. Field of the Invention

The present invention relates to an LCD, and more particularly, to an LCD with sub-pixels rearrangement.

2. Description of the Prior Art

Active matrix type liquid crystal display (LCD) devices have an active element (e.g. a thin-film transistor, TFT) on a per-pixel basis for performing switching operations. The LCD controls light transmittance of liquid crystal material in accordance with a video signal so that a picture corresponding to the video signal can be displayed on the LCD panel. The LCD includes an LCD panel having liquid crystal cells arranged in a matrix shape, and driving circuits for driving the LCD panel. In the LCD panel, a plurality of data lines and a plurality of scan lines intersect, and pixel-driving TFT switches are provided at respective intersections. The driving circuits of the LCD include a source driver for supplying signals displaying the picture to the data lines, and a gate driver for supplying signals turning on/off the TFT switches to the scan lines.

Please refer to FIG. 1. FIG. 1 is a diagram of an LCD 10 according to the prior art. The LCD 10 comprises a display panel 12, a source driver 14, a gate driver 16, and a timing controller 18. The display panel 12 comprises N columns and M rows of pixel units, where N and M are positive integers. Each pixel unit comprises a red sub-pixel (R), a green sub-pixel (G), and a blue sub-pixel (B), and each pixel unit is driven by three data lines and one scan line. Thus, the gate driver 16 comprises M scan lines and the source driver 14 comprises 3N data lines. In FIG. 1, D1 represents the first data line; D3N represents the 3Nth data line; Y1 represents the first scan line; YM represents Mth scan line; 1R1 represents the red sub-pixel at the first column and the first row; and NBM represents the blue sub-pixel at the Nth column and the Mth row. When the gate driver 16 turns on a scan line, the source driver 14 outputs a row of image data through the 3N data lines. Thus, the timing controller 18 controls the source driver 14 and the gate driver 16 so that when each scan line is turned on in sequence, the display panel 12 can display a picture. For example, when the gate driver 16 turns on the scan lines Y1, Y2, Y3 in sequence, the image data of the sub-pixels 1R1, 1R2, and 1R3 are outputted from the data line D1 correspondingly, and the image data of the sub-pixels NB1, NB2, and NB3 are outputted from the data line D3N correspondingly.

There are three driving methods used for LCD devices: a frame-inversion method, a line-inversion method, and a dot-inversion method. In the frame-inversion method, polarities of data applied to each liquid crystal cell are inverted with respect to alternating display frames. The line-inversion driving method includes column-inversion and row-inversion. When driving an LCD device based on the column-inversion method, the polarities of data applied to each liquid crystal cell are inverted with respect to alternating scan lines. Thus, the polarities of the data of the data lines are constant, so the column-inversion method can save power consumption. In the dot-inversion system, data signals having opposite polarities are applied to adjacent liquid crystal cells. Among these three LCD panel driving methods, the dot-inversion system allows a certain liquid crystal cell to have a data signal having a polarity contrary to data signals applied to its adjacent liquid crystal cells in the vertical and horizontal directions, thereby providing a picture having a better quality than the pictures provided by the frame-inversion and line-inversion systems. In light of this advantage, recent LCD panels have mainly used the dot-inversion driving method or system.

With increasing demands for larger display screen sizes and high-resolution applications, there is a tendency to increase number of data lines and scan lines, especially multiplication of the data lines. In addition, technology of the gate driver formed with thin film transistors on the display panel array is developed. Thus, if the number of the data lines of the display panel is optimized to the minimum, the development of the display panel having the large size and high-resolution is advanced.

### SUMMARY OF THE INVENTION

According to an embodiment of the present invention, a display module, comprising: a display panel comprising a pixel array having N columns and M rows of pixel units, each pixel unit having a first sub-pixel, a second sub-pixel, and a third sub-pixel, wherein N and M are positive integers; a source driver comprising N+1 data lines coupled to the N columns of the pixel units for driving the display panel; a gate driver comprising 3M scan lines coupled to the M rows of the pixel units for driving the display panel; a timing controller for receiving an image data and controlling the source driver and the gate driver; and a data converter coupled between the timing controller and the source driver for converting the image data to data of the pixel array.

According to another embodiment of the present invention, a display module, comprising: a display panel comprising a pixel array having N columns and M rows of pixel units, each pixel unit having a first sub-pixel, a second sub-pixel, and a third sub-pixel, wherein N and M are positive integers; a source driver comprising N+1 data lines coupled to the N columns of the pixel units for driving the display panel; a gate driver comprising 3M+1 scan lines coupled to the M rows of the pixel units for driving the display panel; a timing controller for receiving an image data and controlling the source driver and the gate driver; and a data converter coupled between the timing controller and the source driver, for converting the image data to data of the pixel array.

According to another embodiment of the present invention, a display module, comprising: a display panel comprising a pixel array having N columns and M rows of pixel units, each pixel unit having a first sub-pixel, a second sub-pixel, and a third sub-pixel, wherein N and M are positive integers; a source driver comprising (3N/2)+1 data lines coupled to the N columns of the pixel units for driving the display panel, wherein N is even; a gate driver comprising 2M scan lines coupled to the M rows of the pixel units for driving the display panel; a timing controller for receiving an image data and controlling the source driver and the gate driver; and a data converter coupled between the timing controller and the source driver for converting the image data to data of the pixel array.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an LCD according to the prior art.

FIG. 2 is a diagram of a first embodiment of an LCD according to the present invention.

FIG. 3 is a diagram of another embodiment of the display panel in FIG. 2.

FIG. 4 is a diagram of a second embodiment of an LCD according to the present invention.

FIG. 5 is a diagram of a third embodiment of an LCD according to the present invention.

FIG. 6 is a diagram of another embodiment of the display panel in FIG. 5.

FIG. 7 is a diagram of another embodiment of the display panel in FIG. 5.

### DETAILED DESCRIPTION

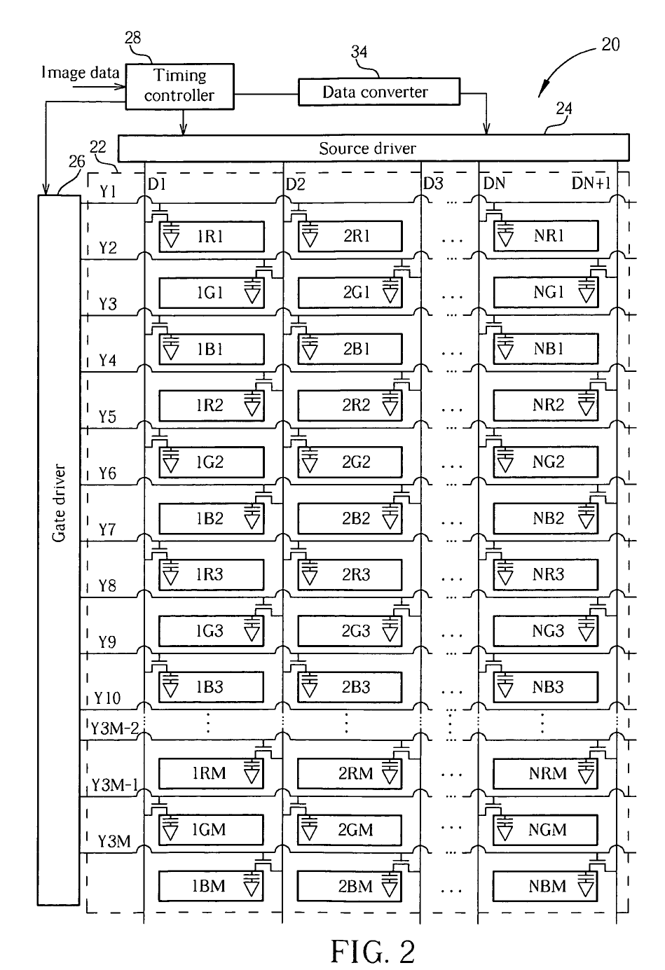

Please refer to FIG. 2. FIG. 2 is a diagram of a first embodiment of an LCD 20 according to the present invention. The LCD 20 comprises a display panel 22, a source driver 24, a gate driver 26, a timing controller 28, and a data converter 34. The display panel 22 comprises N columns and M rows of pixel units, where N and M are positive integers. Each pixel unit comprises a first sub-pixel, a second sub-pixel, and a third sub-pixel, that is, red, green, and blue sub-pixels respectively. Basically, each pixel unit is driven by three data lines and one scan line. In FIG. 2, D1 represents the first data line; DN represents the Nth data line; Y1 represents the first scan line; Y3M represents a 3Mth scan line; 1R1 represents the red sub-pixel at the first column and the first row; and NBM represents the blue sub-pixel at the Nth column and the Mth row. In the first embodiment, the gate driver 26 comprises 3M scan lines and the source driver 24 comprises N+N data lines. According to the different applications, the first data line and the last data line can output the data individually or be coupled together. In this embodiment, the data line D1 is coupled to the data line DN+1. The number of the scan lines will affect the charging time of the pixel units, so the source driver 24 can drive the pixel units with a column-inversion method so as to improve the insufficient charging time of the pixel units. In addition, for the picture having better quality with the dot-inversion method, the sub-pixels of the display panel 22 are rearranged properly, so that the picture can be displayed with the dot-inversion method.

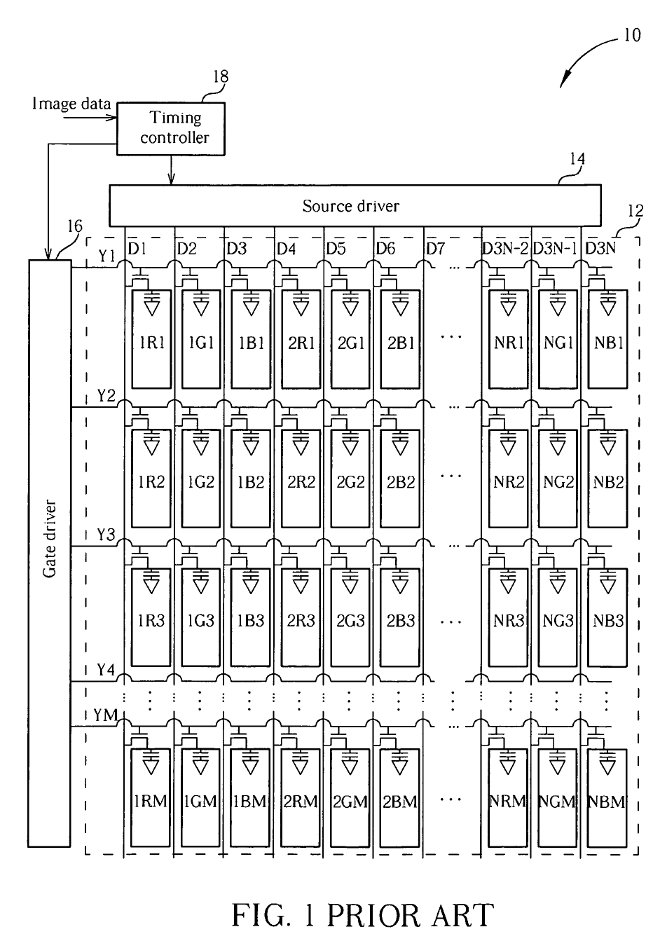

In the display panel 22, the pixel unit at the first column and the first row comprises sub-pixels 1R1, 1G1, and 1B1. The sub-pixel 1R1 is coupled to the data line D1 and the scan line Y1; the sub-pixel 1 G1 is coupled to the data line D2 and the scan line Y2; and the sub-pixel 1B1 is coupled to the data line D1 and the scan line Y3. The pixel unit at the first column and the second row comprises the sub-pixels 1R2, 1G2, and 1B2. The sub-pixel 1R2 is coupled to the data line D2 and the scan line Y4; the sub-pixel 1G2 is coupled to the data line D1 and the scan line Y5; and the sub-pixel 1B2 is coupled to the data line D2 and the scan line Y6. Thus, in the same frame, when the source driver 24 outputs the driving voltages with the column-inversion method, the data lines D1 and D3 output the voltage of the positive polarity, and the data line D2 outputs the voltage of the negative polarity. The sub-pixels 1R1, 1B1, and 2G1 are of the positive polarity, and the sub-pixels 1G1, 2R1, and 2B1 are of the negative polarity, so the picture is displayed with the dot-inversion method. In addition, the timing controller 28 receives image data and controls the source driver 24 and the gate driver 26. When the display panel 12 in FIG. 1 is used, the data line D1 outputs the image data of the sub-pixels 1R1, 1R2, and 1R3 in sequence; the data line D2 outputs the image data of the sub-pixels 1G1, 1G2, and 1G3 in sequence; and the data line D3 outputs the image data of the sub-pixels 1B1, 1B2, and 1B3 in sequence. When the display panel 22 in FIG. 2 is used instead, the data converter 34 can convert the image data. Thus, the data line D1 outputs the image data of the sub-pixels 1R1, NG1, and 1B1 in sequence; the data line D2 outputs the image data of the sub-pixels 2R1, 1G1, and 2B1; and the data line D3 outputs the image data of the sub-pixels 3R1, 2G1, and 3B1.

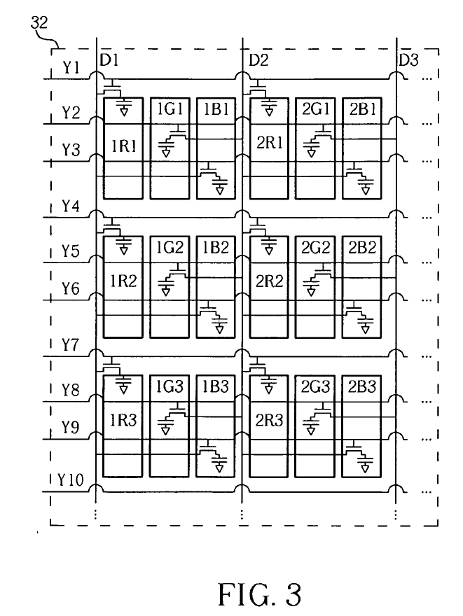

Please refer to FIG. 3. FIG. 3 is a diagram of another embodiment of the display panel in FIG. 2. In FIG. 2, the sub-pixels of each pixel unit of the display panel 22 are arranged in a vertical direction. In FIG. 3, the sub-pixels of each pixel unit of the display panel 32 are arranged in a horizontal direction. However, the connection of the sub-pixels of the display panel 32 with the data lines and the scan lines is identical to the display panel 22, so the driving method is the same.

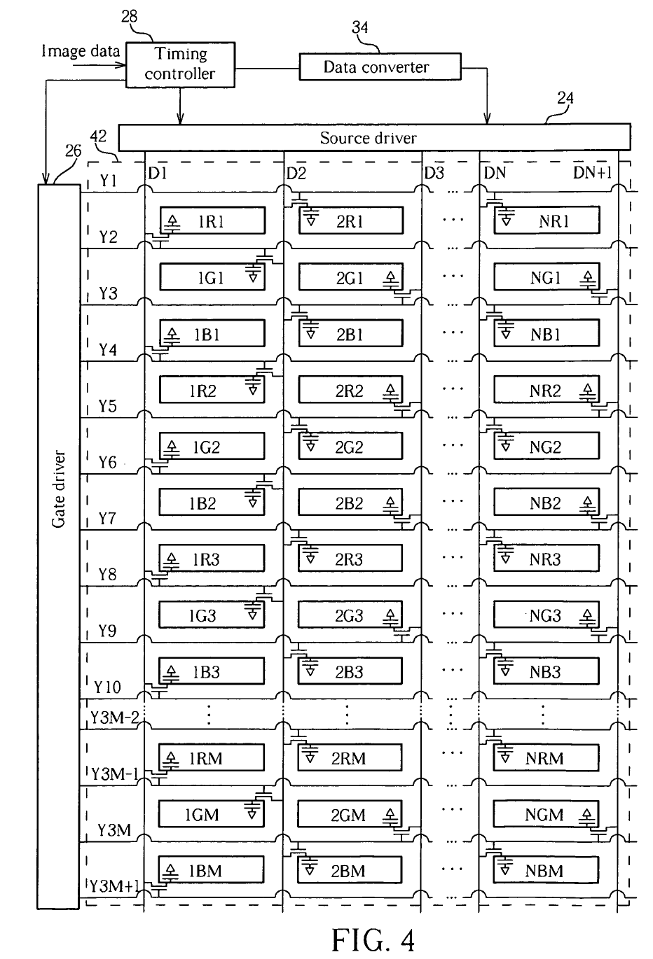

Please refer to FIG. 4. FIG. 4 is a diagram of a second embodiment of an LCD according to the present invention. In the second embodiment, the gate driver 26 comprises 3M+1 scan lines, and the source driver 24 comprises N+1 data lines. The data line D1 is coupled to the data line DN+1, so the connection of the sub-pixels of the display panel 42 with the data lines and the scan lines is different from the first embodiment. In the display panel 42, the pixel unit at the first column and the first row comprises the sub-pixels 1R1, 1G1, and 1B1. The sub-pixel 1R1 is coupled to the data line D1 and the scan line Y2; the sub-pixel 1G1 is coupled to the data line D2 and the scan line Y2; and the sub-pixel 1B1 is coupled to the data line D1 and the scan line Y4. The pixel unit at the second column and the first row comprises the sub-pixels 2R1, 2G1, and 2B1. The sub-pixel 2R1 is coupled to data line D2 and the scan line Y1, the sub-pixel 2G1 is coupled to data line D3 and the scan line Y3, and the sub-pixel 2B1 is coupled to data line D2 and the scan line Y3. The pixel unit at the first column and the second row comprises the sub-pixels 1R2, 1G2, and 1B2. The sub-pixel 1R2 is coupled to data line D2 and the scan line Y4; the sub-pixel 1G2 is coupled to data line D1 and the scan line Y6; and the sub-pixel 1B2 is coupled to data line D2 and the scan line Y6. The pixel unit at the second column and the second row comprises the sub-pixels 2R2, 2G2, and 2B2. The sub-pixel 2R2 is coupled to data line D3 and the scan line Y5; the sub-pixel 2G2 is coupled to data line D2 and the scan line Y5; and the sub-pixel 2B2 is coupled to data line D3 and the scan line Y7. However, the connection of the sub-pixels of the display panel 42 with the data lines and the scan lines is different from the first embodiment, and the data converter 34 can convert the image data in accordance with the display panel 42.

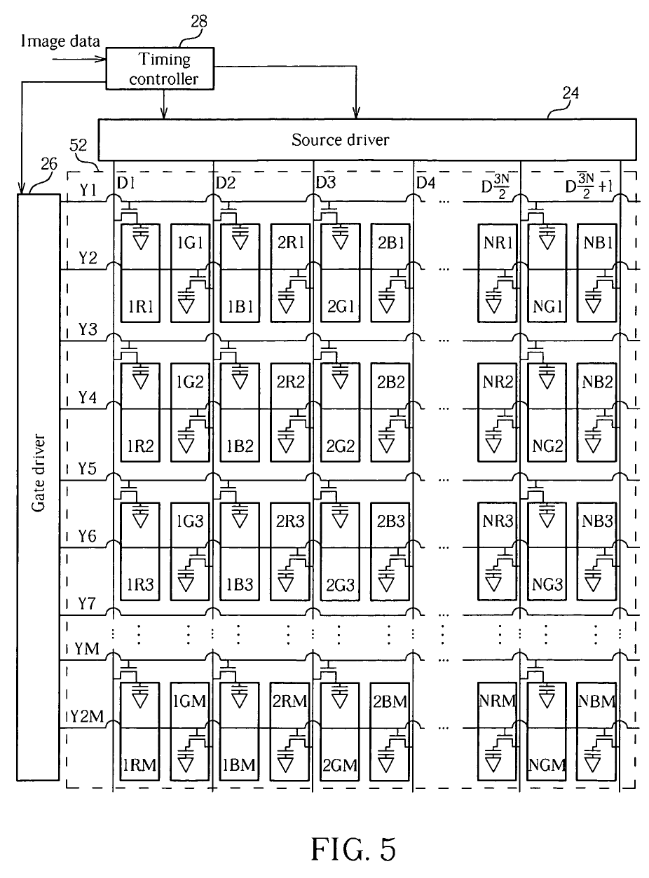

Please refer to FIG. 5. FIG. 5 is a diagram of a third embodiment of an LCD according to the present invention. In the third embodiment, each pixel unit is driven by two data line and two scan lines basically. When N is even, the display panel 52 comprises (3N/2)+1 data lines and 2M scan lines. In the description of this embodiment, the data line D1 is coupled to the data line D(3N/2)+1. In addition, when N is odd, the display panel 52 comprises (3N+1)/2 data lines. In the display panel 52, the pixel unit at the first column and the first row comprises the sub-pixels 1R1, 1G1, and 1B1. The sub-pixel 1R1 is coupled to the data line D1 and the scan line Y1; the sub-pixel 1G1 is coupled to the data line D2 and the scan line Y2; and the sub-pixel 1B1 is coupled to the data line D2 and the scan line Y1. The pixel unit at the second column and the first row comprises the sub-pixels 2R1, 2G1, and 2B1. The sub-pixel 2R1 is coupled to the data line D3 and the scan line Y2; the sub-pixel 2G1 is coupled to the data line D3 and the scan line Y1; and the sub-pixel 2B1 is coupled to the data line D4 and the scan line Y2. When the display panel 52 is used, the data converter 34 can convert the image data. Thus, the data line D1 outputs the image of the sub-pixels 1R1, NB1, and 1R2 in sequence; the data line D2 outputs the image data of the sub-pixels 1B1, 1G1, and 1B2 in sequence; and the data line D3 outputs the image data of the sub-pixels 2G1, 2R1, and 2G2 in sequence.

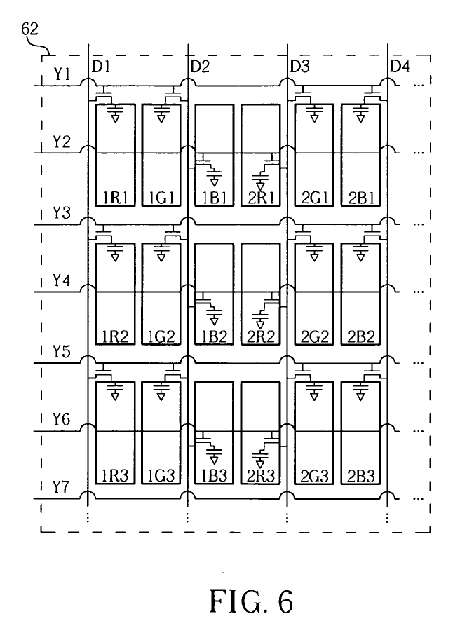

Please refer to FIG. 6. FIG. 6 is a diagram of another embodiment of the display panel in FIG. 5. The connection of the sub-pixels of the display panel 62 in FIG. 6 with the data lines and the scan lines is different to the display panel 52 in FIG. 5. In the display panel 62, the pixel unit at the first column and the first row comprises the sub-pixels 1R1, 1G1, and 1B1. The sub-pixel 1R1 is coupled to the data line D1 and the scan line Y1; the sub-pixel 1 G1 is coupled to the data line D2 and the scan line Y1; and the sub-pixel 1B1 is coupled to the data line D2 and the scan line Y2. The pixel unit at the second column and the first row comprises the sub-pixels 2R1, 2G1, and 2B1. The sub-pixel 2R1 is coupled to the data line D3 and the scan line Y2; the sub-pixel 2G1 is coupled to the data line D3 and the scan line Y1; and the sub-pixel 2B1 is coupled to the data line D4 and the scan line Y1. When the display panel 62 is used, the data converter 34 can convert the image data. Thus, the data line D1 outputs the image data of the sub-pixels 1R1, NB1, and 1R2 in sequence; the data line D2 outputs the image data of the sub-pixels 1G1, 1B1, and 1G2 in sequence; and the data line D3 outputs the image data of the sub-pixels 2G1, 2R1, and 2G2 in sequence.

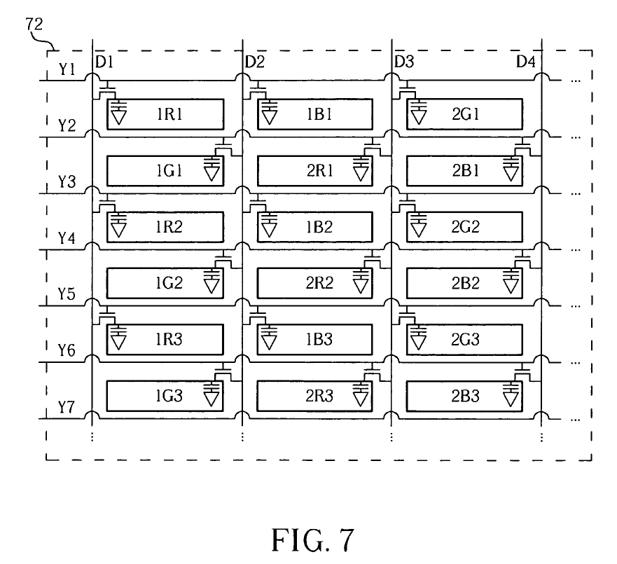

Please refer to FIG. 7. FIG. 7 is a diagram of another embodiment of the display panel in FIG. 5. The connection of the sub-pixels of the display panel 72 in FIG. 7 with the data lines and the scan lines is different from the display panel 52 in FIG. 5. In the display panel 72, the pixel unit at the first column and the first row comprises the sub-pixels 1R1, 1G1, and 1B1. The sub-pixel 1R1 is coupled to the data line D1 and the scan line Y1; the sub-pixel 1G1 is coupled to the data line D2 and the scan line Y2; and the sub-pixel 1B1 is coupled to the data line D2 and the scan line Y1. The pixel unit at the second column and the first row comprises the sub-pixels 2R1, 2G1, and 2B1. The sub-pixel 2R1 is coupled to the data line D3 and the scan line Y2; the sub-pixel 2G1 is coupled to the data line D3 and the scan line Y1; and the sub-pixel 2B1 is coupled to the data line D4 and the scan line Y2. When the display panel 72 is used, the data converter 34 can convert the image data. Thus, the data line D1 outputs the image data of the sub-pixels 1R1, NB1, and 1R2 in sequence; the data line D2 outputs the image data of the sub-pixels 1B1, 1G1, and 1B2 in sequence; and the data line D3 outputs the image data of the sub-pixels 2G1, 2R1, and 2G2 in sequence. In addition, when the source driver 24 outputs the driving voltage with the column-inversion method, the data line D1 and D3 output the voltage of the positive polarity, and the data line D2 and D4 output the voltage of the negative polarity. The sub-pixels 1R1, 1R2, 2R1, 2G1 and 2G2 are of the positive polarity, and the sub-pixels 1G1, 1B1, 1B2 and 2B1 are of the negative polarity, so the picture is displayed with the dot-inversion method.

In conclusion, the LCD according to the present invention utilizes fewer data lines to drive the display panel, though the number of the scan lines is increased comparatively; however, the gate driver can be formed with thin film transistors on the display panel array. The number of the scan lines will affect the charging time of the pixel units, so the source driver can drive the pixel units with the column-inversion method so as to improve the insufficient charging time of the pixel units. In addition, for the picture having better quality displayed with the dot-inversion method, the sub-pixels of the display panel are rearranged properly, so that the picture can be displayed with the dot-inversion method and the power consumption of the LCD can be saved with the column-inversion method. In the embodiment of the present invention, the display panel comprises N columns and M rows of pixel units, where N and M are positive integers. Each pixel unit comprises a first sub-pixel, a second sub-pixel, and a third sub-pixel. For the display panel having fewer data lines, the first sub-pixel, the second sub-pixel, and the third sub-pixel of the pixel unit are driven according to one data line and three scan lines. In addition, the first sub-pixel, the second sub-pixel, and the third sub-pixel of the pixel unit can be driven according to two data lines and two scan lines. Thus, after the sub-pixels of the display panel are rearranged properly, the embodiments according to the present invention include: 1) N+1 data lines and 3M scan lines are utilized to drive the display panel; 2) N+1 data lines and 3M+1 scan lines are utilized to drive the display panel; and 3) (3N/2)+1 data lines and 2M scan lines are utilized to drive the display panel.

Those skilled in the art will readily observe that numerous modifications and alterations of the device and method may be made while retaining the teachings of the invention.

What is claimed is:

1. A display module, comprising:
a display panel comprising a pixel array having N columns and M rows of pixel units, each pixel unit having a first sub-pixel, a second sub-pixel, and a third sub-pixel, wherein N and M are positive integers;
a source driver comprising N+1 data lines coupled to the N columns of the pixel units for driving the display panel;
a gate driver comprising 3M scan lines coupled to the M rows of the pixel units for driving the display panel;
a timing controller for receiving an image data and controlling the source driver and the gate driver; and
a data converter coupled between the timing controller and the source driver for converting the image data to data of the pixel array.

2. The display module of claim 1, wherein the first sub-pixel, the second sub-pixel, and the third sub-pixel of each pixel unit are coupled to three scan lines respectively.

3. The display module of claim 1, wherein the source driver utilizes a column-inversion method for outputting driving voltages according to the data of the pixel array.

4. The display module of claim 1, wherein the display panel comprises a first pixel unit having a first sub-pixel coupled to a first data line and a first scan line, a second sub-pixel coupled to a second data line and a second scan line, and a third sub-pixel coupled to the first data line and a third scan line.

5. The display module of claim 4, wherein the display panel further comprises a second pixel unit having a first sub-pixel coupled to the second data line and a fourth scan line, a second sub-pixel coupled to the first data line and a fifth scan line, and a third sub-pixel coupled to the second data line and a sixth scan line.

6. A display module, comprising:
a display panel comprising a pixel array having N columns and M rows of pixel units, each pixel unit having a first sub-pixel, a second sub-pixel, and a third sub-pixel, wherein N and M are positive integers;
a source driver comprising N+1 data lines coupled to the N columns of the pixel units for driving the display panel;
a gate driver comprising 3M+1 scan lines coupled to the M rows of the pixel units for driving the display panel;
a timing controller for receiving an image data and controlling the source driver and the gate driver; and
a data converter coupled between the timing controller and the source driver, for converting the image data to data of the pixel array.

7. The display module of claim 6, wherein the source driver utilizes column-inversion for outputting driving voltages according to the data of the pixel array.

8. The display module of claim 6, wherein the display panel comprises a first pixel unit having a first sub-pixel coupled to a first data line and a second scan line, a second sub-pixel coupled to a second data line and the second scan line, and a third sub-pixel coupled to the first data line and a fourth scan line.

9. The display module of claim 8, wherein the display panel further comprises a second pixel unit having a first sub-pixel coupled to the second data line and a first scan line, a second sub-pixel coupled to a third data line and a third scan line, and a third sub-pixel coupled to the second data line and the third scan line.

10. The display module of claim 8, wherein the display panel further comprises a third pixel unit having a first sub-pixel coupled to the second data line and the fourth scan line, a second sub-pixel coupled to the first data line and a sixth scan line, and a third sub-pixel coupled to the second data line and the sixth scan line.

11. The display module of claim 8, wherein the display panel further comprises a fourth pixel unit having a first sub-pixel coupled to a third data line and a fifth scan line, a second sub-pixel coupled to the second data line and the fifth scan line, and a third sub-pixel coupled to the third data line and a seventh scan line.

12. A display module, comprising:
a display panel comprising a pixel array having N columns and M rows of pixel units, each pixel unit having a first sub-pixel, a second sub-pixel, and a third sub-pixel, wherein N and M are positive integers;
a source driver comprising (3N/2)+1 data lines coupled to the N columns of the pixel units for driving the display panel, wherein N is even;
a gate driver comprising 2M scan lines coupled to the M rows of the pixel units for driving the display panel;
a timing controller for receiving an image data and controlling the source driver and the gate driver; and
a data converter coupled between the timing controller and the source driver for converting the image data to data of the pixel array.

13. The display module of claim 12, wherein the source driver comprises (3N+1)/2 data lines coupled to the N columns of the pixel units for driving the display panel, and N is odd.

14. The display module of claim 12, wherein the source driver utilizes a column-inversion method for outputting driving voltages according to the data of the pixel array.

15. The display module of claim 12, wherein the display panel comprises a first pixel unit having a first sub-pixel coupled to a first data line and a first scan line, a second sub-pixel coupled to a second data line and a second scan line, and a third sub-pixel coupled to the second data line and the first scan line.

16. The display module of claim 15, wherein the display panel further comprises a second pixel unit having a first sub-pixel coupled to a third data line and the second scan line, a second sub-pixel coupled to the third data line and the first scan line, and a third sub-pixel coupled to a fourth data line and the second scan line.

17. The display module of claim 12, wherein the display panel comprises a first pixel unit having a first sub-pixel coupled to a first data line and a first scan line, a second sub-pixel coupled to a second data line and the first scan line, and a third sub-pixel coupled to the second data line and the second scan line.

18. The display module of claim 17, wherein the display panel further comprises a second pixel unit having a first sub-pixel coupled to a third data line and the second scan line, a second sub-pixel coupled to the third data line and the first scan line, and a third sub-pixel coupled to a fourth data line and the first scan line.
